(19) United States
(12) Patent Application Publication
(10) Pub. No.: US 2011/0216287 A1
(43) Pub. Date: Sep. 8, 2011

(54) VIDEO PROJECTOR

(75) Inventors: Satoshi Kitamura, Hirakata-shi (JP); Shinya Noda, Neyagawa-shi (JP)

(73) Assignee: SANYO ELECTRIC CO., LTD., Osaka (JP)

(21) Appl. No.: 13/038,769

(22) Filed: Mar. 2, 2011

(30) Foreign Application Priority Data
Mar. 4, 2010 (JP) 2010-048100

(51) Int. Cl. G03B 21/16

(52) U.S. Cl. 353/61

(57) ABSTRACT

A video projector including a lamp cooling system that cools a light source lamp. The lamp cooling system includes an airflow deflection unit that varies the direction in which cooling air flows when a projection direction of the video projector changes. The airflow deflection unit uses gravitational force to automatically change the direction in which cooling air flows so that the cooling air is concentrated at an upper portion of the arc tube regardless of the changed video projector.

### CROSS-REFERENCE TO RELATED APPLICATIONS

This application is based upon and claims the benefit of priority from prior Japanese Patent Application No. 2010-048100, filed on Mar. 4, 2010, the entire contents of which are incorporated herein by reference.

### BACKGROUND ART

The present invention relates to a video projector that uses air to cool a light source lamp.

A video projector includes a light source lamp such as a metal halide lamp. A light source lamp includes an arc tube. As viewed in the direction gravitational force acts, that is, in the vertical direction, the arc tube of the light source includes an upper portion and a lower portion. The temperature of the upper portion becomes higher than that of the lower portion. The temperature of the overall arc tube in the light source lamp must be kept within an optimal range to increase the performance of the light source lamp to the highest level and prolong the life of the light source lamp.

The video projector may be arranged in various positions, or states, in accordance to where it is used. For example, the video projector may be arranged in an upright projection state or a suspended projection state among other states. In the upright projection state, the video projector is arranged on a flat plane, such as a floor or a table. In the suspended projection state, the video projector is suspended from the ceiling. When the video projector is changed from the upright projection state to the suspended projection state or vice-versa, the main body of the video projector is turned upside down. This arranges the arc tube of the light source lamp upside down. Thus, regardless of the state of the video projector, the cooling strength distribution must be varied in accordance with the position of the video projector so that the upper portion of the arc tube is strongly cooled and the lower portion of the arc tube is weakly cooled.

Japanese Laid-Open Patent Publication No. 2007-233420 describes a cooling structure that pivots a current deflection plate to partially close an air intake port, which is in communication with an air intake passage. The air drawn through the open part of the air intake port is directly delivered to the upper portion of the arc tube.

Japanese Laid-Open Patent Publication No. 2009-99269 describes an example of a cooling structure that includes a deflection unit and upper and lower outlet ducts for the light source lamp. When the video projector is turned upside down, the deflection unit switches the outlet duct from which air flows out so that air is always delivered to only the upper portion of the arc tube. Japanese Laid-Open Patent Publication No. 9-304835 describes a fin that switches passages and directions in which air flows so that air is selectively delivered to the upper and lower portions of the light source lamp. When the video projector is turned upside down, the cooling structure switches passages with the fin so that air is always delivered to only the upper portion of the arc tube. The air from the lower passage directed toward the lower portion of the arc tube is also diverted upward by the fin.

### SUMMARY OF THE INVENTION

The cooling structures of the prior art may be effective when the video projector is in the upright projection state or the suspended projection state. However, these structures are not effective when the video projector is arranged in an upwardly directed projection state, in which it projects images in an upward direction, or a downwardly directed projection state, in which it projects images in a downward direction.

Further, in the '420 publication, the air intake port is partially closed when the projector is arranged in the suspended projection state. This concentrates the flow of air only at part of the arc tube in the axial direction. Thus, the temperature distribution may be biased in the arc tube. When the video projector is arranged in the upright projection state, half of the cooling air is directed to the lower portion of the arc tube in the vertical direction. Thus, when using a high output lamp, the lower portion of the arc tube is overcooled. This makes it difficult to concentrate cooling at the upper portion of the arc tube. In the '269 publication and the '835 publication, half of the cooling air flowing toward the arc tube is unnecessary. This consumes additional power.

One aspect of the present invention is a video projector including a housing. A light source lamp is accommodated in the housing and includes an optical axis, an arc tube, and a reflector that reflects light generated by the arc tube. A lamp cooling system uses air to cool the arc tube and includes an airflow deflection unit. When the housing is rotated about the optical axis of the light source lamp to change a projection direction of the video projector, the airflow deflection unit automatically changes a direction in which cooling air flows using gravitational force so that the cooling air is concentrated at an upper portion of the arc tube regardless of the changed projection direction.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a video projector according to one embodiment of the present invention;

FIG. 2 is a schematic diagram shown an optical system of the video projector;

FIG. 3(a) is a partial cross-sectional view showing a light source lamp and cooling system;

FIG. 3(b) is a front view showing the light source lamp and cooling system;

FIG. 4 is an exploded perspective view showing the light source lamp;

FIG. 5 is a perspective view showing an airflow deflection unit of the cooling system;

FIG. 6(a) is a perspective view showing the airflow deflection unit;

FIG. 6(b) is a plan view showing the airflow deflection unit when the projector is arranged in an upright projection state;

FIG. 6(c) is a plan view showing the airflow deflection unit when the projector is arranged in a suspended projection state;

FIG. 6(d) is a plan view showing the current deflection when the projector is arranged in an upwardly directed projection state or downwardly directed projection state;

FIG. 7(a) is a perspective view showing the projector arranged in the upright projection state above a horizontal plane;

FIG. 7(b) is a diagram showing the flow of air in the state of FIG. 7(a);

FIG. 8(a) is a perspective view showing the projector arranged in the suspended projection state below a horizontal plane;

FIG. 8(b) is a diagram showing the flow of air in the state of FIG. 8(a);

FIG. 9(a) is a perspective view showing the projector arranged in the upwardly directed projection state beside a vertical plane;

FIG. 9(b) is a diagram showing the flow of air in the state of FIG. 9(a);

FIG. 10(a) is a perspective view showing the projector arranged in the downwardly directed projection state beside a vertical plane;

FIG. 10(b) is a diagram showing the flow of air in the state of FIG. 10(a); and

FIG. 11 is a perspective view showing a modified example of the airflow deflection unit.

### DETAILED DESCRIPTION OF THE INVENTION

A video projector according to one embodiment of the present invention will now be discussed with reference to the drawings.

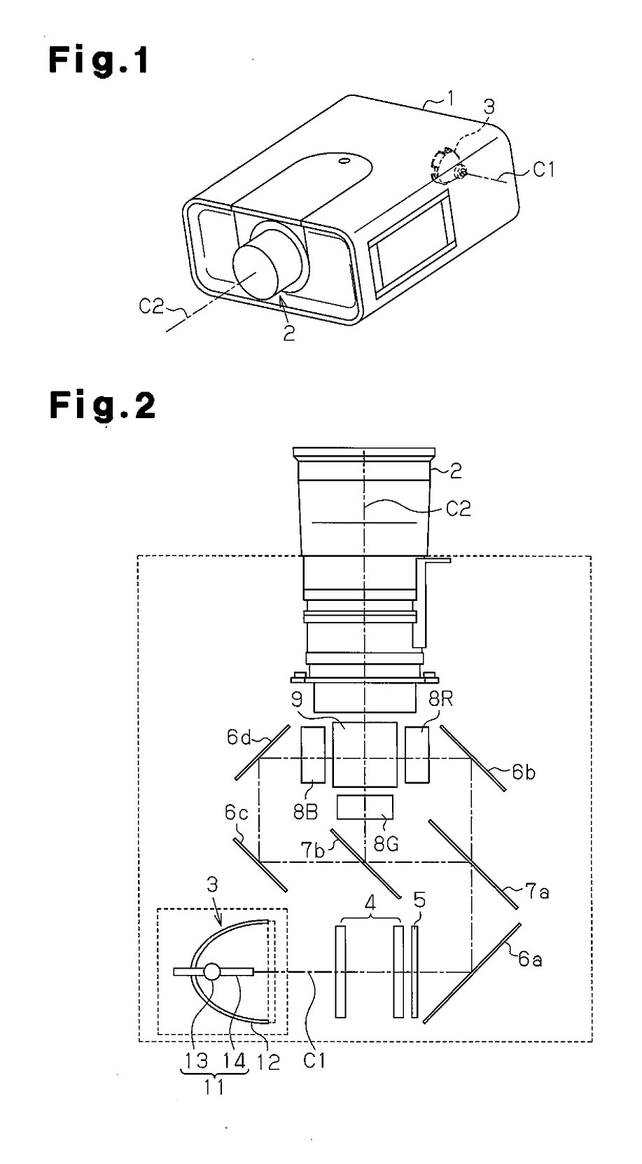

Referring to FIG. 1, the video projector of the embodiment is a three-chip LCD projector including a housing 1 and a projection lens 2, which is arranged on the front surface of the housing 1. FIG. 1 is a perspective view taken from a diagonally upward position showing the video projector in an upright projection state. In the description hereafter, unless otherwise specified, the direction of gravity will be used as a frame of reference that defines the upward and downward directions. Thus, the upper and lower sides of the projector as viewed in FIG. 1 would be reversed when the projector is suspended from a ceiling. Further, the frontward direction of the projector refers to the direction in which light travels.

The video projector includes an optical system, which will now be described with reference to FIG. 2. The optical system includes optical elements such as a light source lamp 3, an integrator lens 4, a polarization conversion element 5, reflection mirrors 6a, 6b, 6c, and 6d, dichroic mirrors 7a and 7b, liquid crystal light valves 8R, 6G, and 8B, a dichroic prism 9, and the projection lens 2.

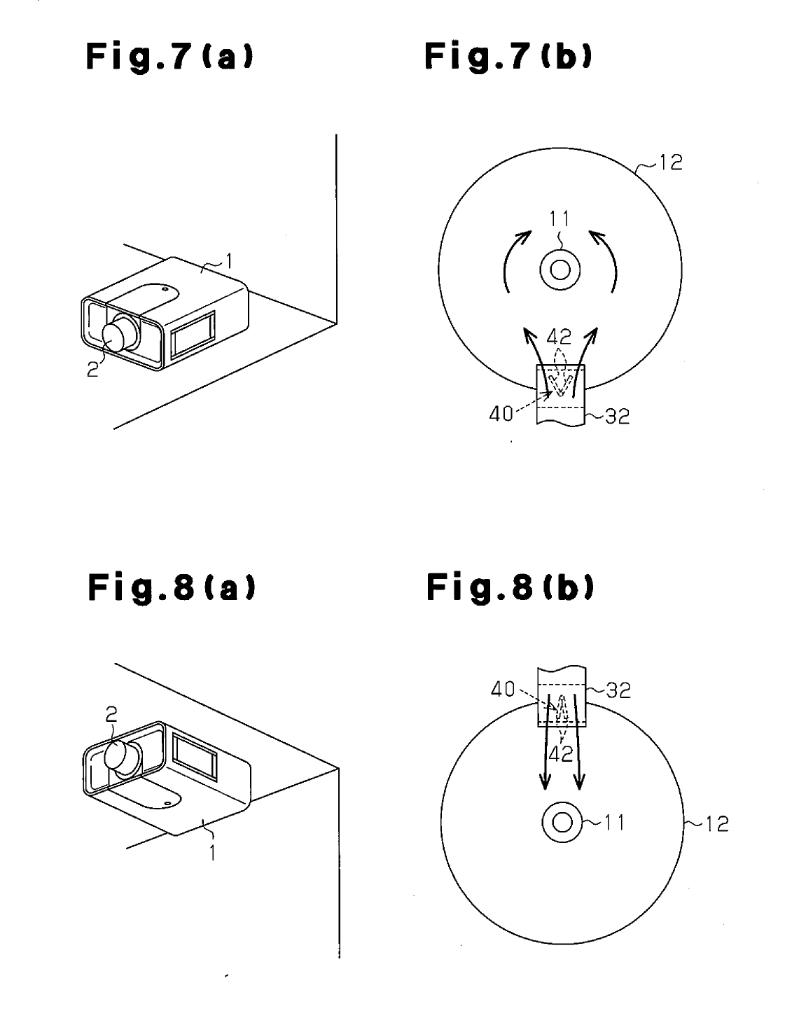

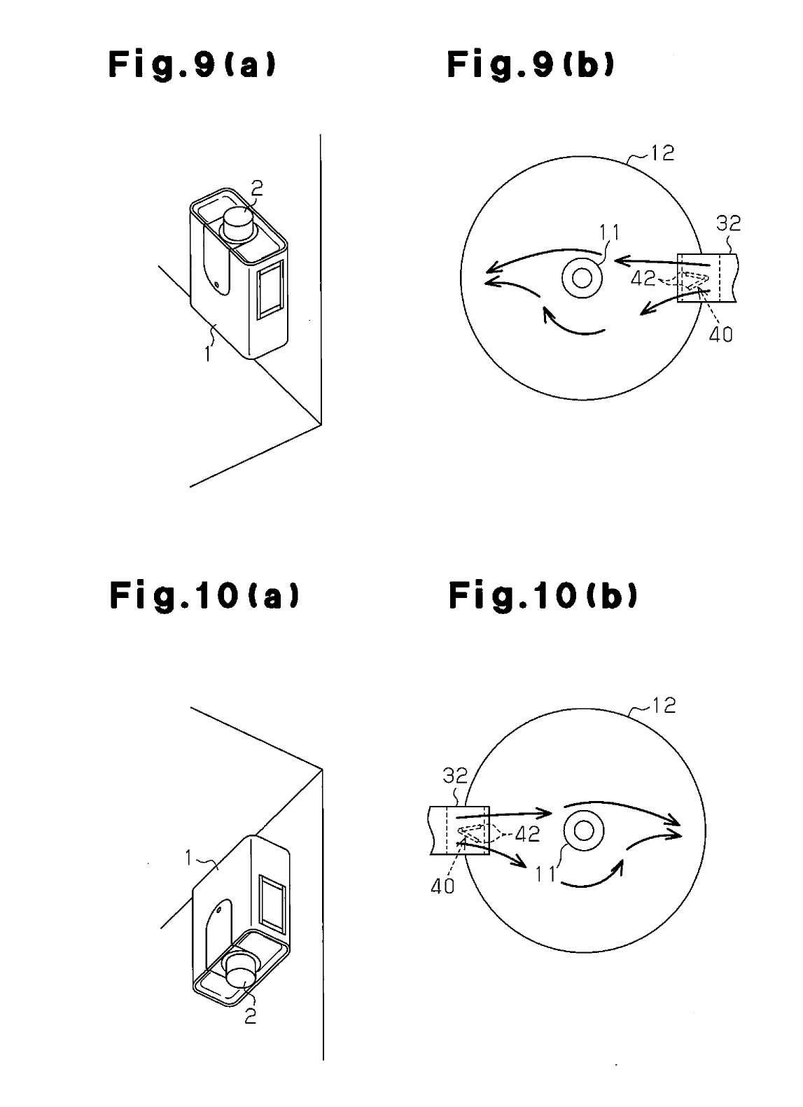

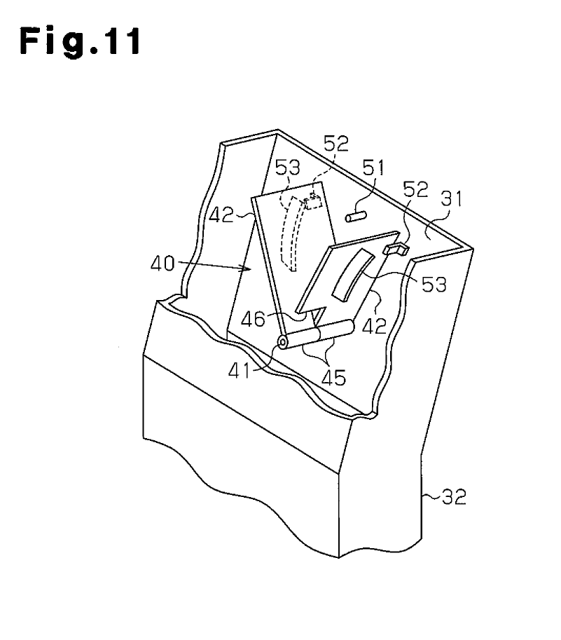

The light source lamp 3 includes an optical axis C1, and the projection lens 2 includes an optical axis C2. The optical elements are laid out so that the optical axes C1 and C2 lie along the same plane and intersect each other at a right angle. Accordingly, by turning the housing 1 about the optical axis C1 of the light source lamp 3, the video projector may be arranged in an upright projection state as shown in FIG. 7(a), a suspended projection state as shown in FIG. 8(a), an upwardly directed projection state as shown in FIG. 9(a), and a downwardly directed projection state as shown in FIG. 10(a).

The light source lamp 3 includes an arc tube 11 and a reflector 12. The arc tube 11 includes a spherical portion 13 and a cylindrical portion 14. The arc tube 11 may be formed from silica glass. The spherical portion 13 contains a luminous body such as a mixture of mercury and halogen gas or a mixture of mercury and a halogen compound. Part of an electrode extending to the spherical portion 13 is embedded in the cylindrical portion 14.

The reflector 12 is open to the front and includes a parabolic reflection surface. The spherical portion 13 is located at the focal point of the reflection surface in the reflector 12. The reflector 12 reflects the light emitted from the arc tube 11 to generate parallel light, which is emitted toward the front from the reflector 12. The interior of the reflector 12 is referred to as a luminous chamber.

The integrator lens 4 is formed by, for example, two fly's eye lenses. Each fly's eye lens includes lens portions configured to irradiate the overall surfaces of the liquid crystal light valves 8R, 8G, and 8B with the light emitted from the light source lamp 3.

The polarization conversion element 5 includes a polarization splitting film and a plurality of polarization beam splitter arrays. The polarization conversion element 5 converts the light from the integrator lens 4 into one type of linearly polarized light and emits the polarized light.

The reflection mirrors 6a, 6b, 6c, and 6d each change the direction in which light travels to a predetermined direction. The dichroic mirrors 7a and 7b separate the light (white light) emitted from the light source lamp 3 into the three primary colors of light, which are red, green, and blue. The dichroic mirror 7a transmits red light and reflects green light and blue light. The dichroic mirror 7b transmits blue light and reflects green light.

The liquid crystal light valve 8R, which is for red light, modulates red light components. The liquid crystal light valve 8G, which is for green light, modulates green light components. The liquid crystal light valve 8B, which is for blue light, modulates blue light components. The liquid crystal light valves 8R, 8G, and 8B each include an entrance side polarization plate, a liquid crystal panel, an optical compensation plate, and an exit side polarization plate (none shown).

The dichroic prism 9 combines the three colors of image light emitted from the liquid crystal light valves 8R, 8G, and 8B to generate image light used for projection. Then, the dichroic prism 9 sends the image light to the projection lens 2.

The projection lens 2 is formed by a group of lenses. The projection lens enlarges the image light from the dichroic prism 9 and projects the image light onto a display surface such as a screen or a wall surface.

A cooling system is used to cool the optical elements of the optical system that have upper tolerable temperatures that are relatively low. The cooling system uses the air in the housing 1 for cooling. Such optical elements having low upper tolerable temperatures include the liquid crystal light valves 8R, 8G, and 8B and the polarization conversion element 5. In addition to the cooling system, the housing 1 includes a lamp cooling system that cools the light source lamp 3, which generates a large amount of heat and is used at an extremely high temperature. The lamp cooling system will now be discussed.

The light source lamp 3 and its surrounding structure will first be described.

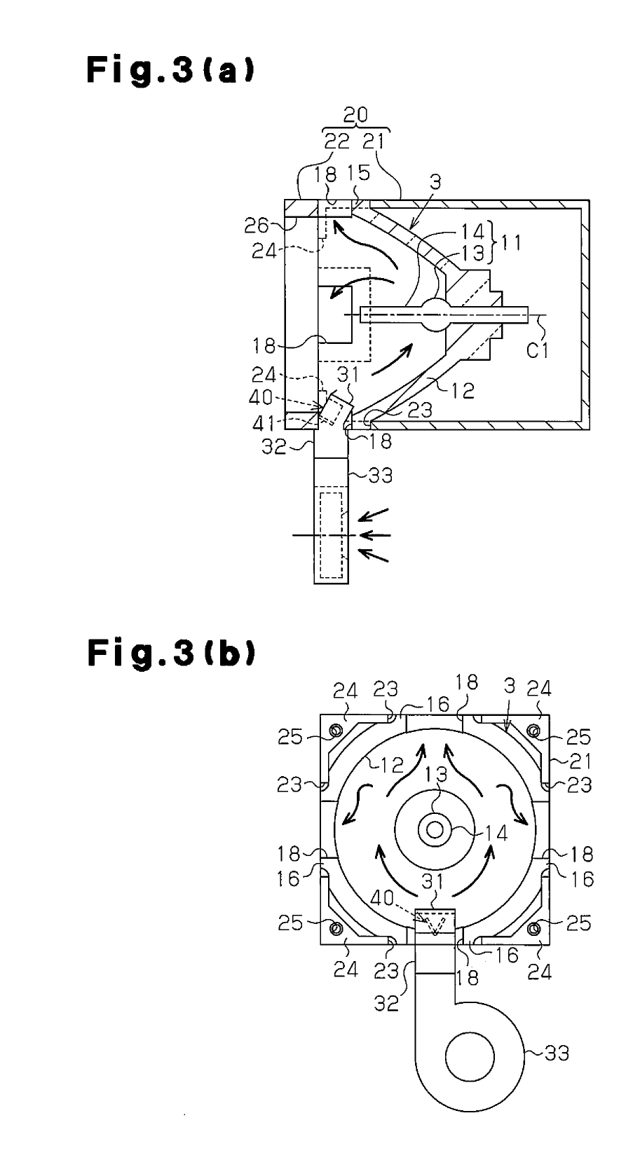

As show in FIG. 3(a), the light source lamp 3 is arranged in a box-shaped lamp case 20. The lamp case 20 includes a box-shaped lamp holder 21, which accommodates the light source lamp 3, and a lamp cover 22, which covers a front opening of the lamp holder 21.

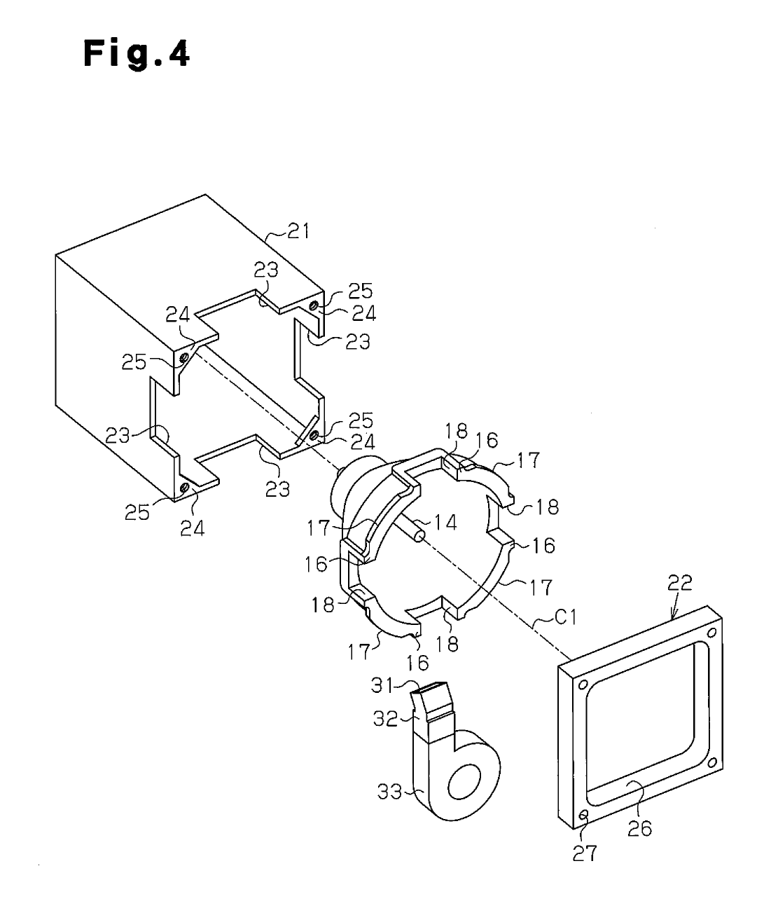

As shown in FIG. 4, the lamp holder 21 includes a front edge that defines the front opening. A slot 23 is formed in the middle of each side wall at the front edge. The four corners at the front edge each include a triangular seat 24. Each seat 24 includes a threaded hole 25, which receives a bolt for fastening the lamp cover 22. The lamp cover 22 may be a frame including a light window 26 through which the emission light from the light source lamp 3 passes. The four corners of the lamp cover 22 each include a bolt hole 27, which is for the bolt that fastens the lamp cover 22.

The reflector 12 of the light source lamp 3 has a rim, or peripheral part, including central portions 16, which correspond to the slots 23 of the lamp holder 21, and corner portions 17, which connect the adjacent central portions 16. In the illustrated example, when seen from the front, each central portion 16 is straight, and each corner portion 17 is arced. Each central portion 16 includes an opening 18 that is cut out. The central portions 16 are fitted into the slots 23 of the lamp holder 21 to accommodate the light source lamp 3 in the lamp holder 21. The lamp cover 22 is attached to the lamp holder 21, in which the light source lamp 3 is accommodated, from the front. This fixes the light source lamp 3 between the lamp holder 21 and the lamp cover 22. Accordingly, as viewed from the front, the outer dimensions of the lamp holder 21, the outer dimensions of the lamp cover 22, and the dimensions between the outer surfaces of the opposing central portions 16 are substantially the same.

The openings 18 serve as ports providing fluid communication between the exterior of the lamp case 20 and the luminous chamber of the light source lamp 3. In the illustrated example, the opening 18 that is located at the lower side when the projector is arranged in the upright projection state receives an air duct 32. The air duct 32 has a distal end defining an air outlet 31. As shown in FIGS. 3(a) and 3(b), cooling air, which is generated by a cooling fan 33, flows out of the air outlet 31. An airflow deflection unit 40 is arranged in the air outlet 31. Each of the openings 18, excluding the one receiving the air duct 32, functions as a discharge port. In this manner, cooling air flows into the luminous chamber of the light source lamp 3 through one of the openings 18 from the exterior of the lamp case 20. After cooling the light source lamp 3, the cooling air smoothly flows out of the lamp case 20 from the luminous chamber of the light source lamp 3 through the remaining openings 18.

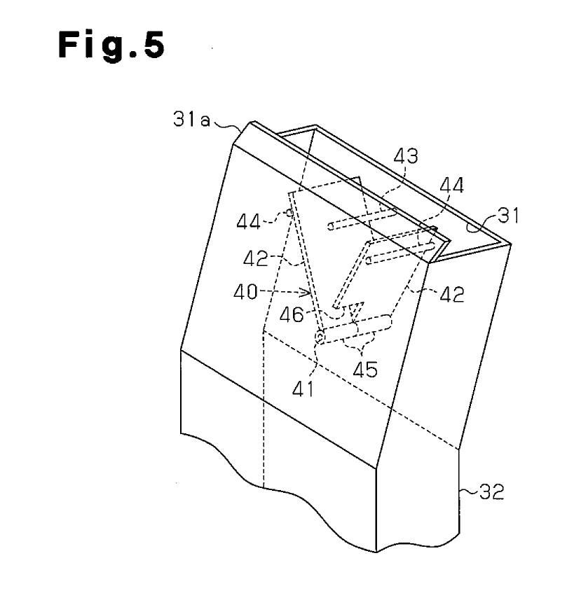

Referring to FIG. 5, cooling air flows out of the air outlet 31 from the rim, or peripheral part, of the reflector 12 and is directed toward an innermost part, or central part, of the reflector 12 that supports a basal end of the arc tube 11. As shown in FIG. 5, the air outlet 31 may be inclined and/or a guide 31a may be formed on the open edge of the air outlet 31 to guide the cooling air flowing out of the air outlet 31 toward the arc tube 11.

The airflow deflection unit 40 will now be described. The airflow deflection unit 40 may be arranged in the air outlet 31. The airflow deflection unit 40 includes, for example, as shown in FIG. 5, two deflection plates 42, which are pivotally supported by a pivot shaft 41, and regulation members, which regulate the pivotal range of the two deflection plates 42. The regulation members include a base position regulation member 43 and two maximum pivot position regulation members 44.

The pivot shaft 41 and the optical axis C1 of the light source lamp 3 lie along a reference plane F. The pivot shaft 41 is coupled to inner walls of the air outlet 31. In the illustrated example, the pivot shaft 41 is located below the optical axis C1 of the light source lamp 3. Further, the pivot shaft 41 is inclined so that its basal end is lower than its distal end. The two deflection plates 42 are independently pivotal about the pivot shaft 41. The pivot shaft 41 allows each deflection plate 42 to pivot when the direction of the air outlet 31 is varied with respect to the vertical direction:

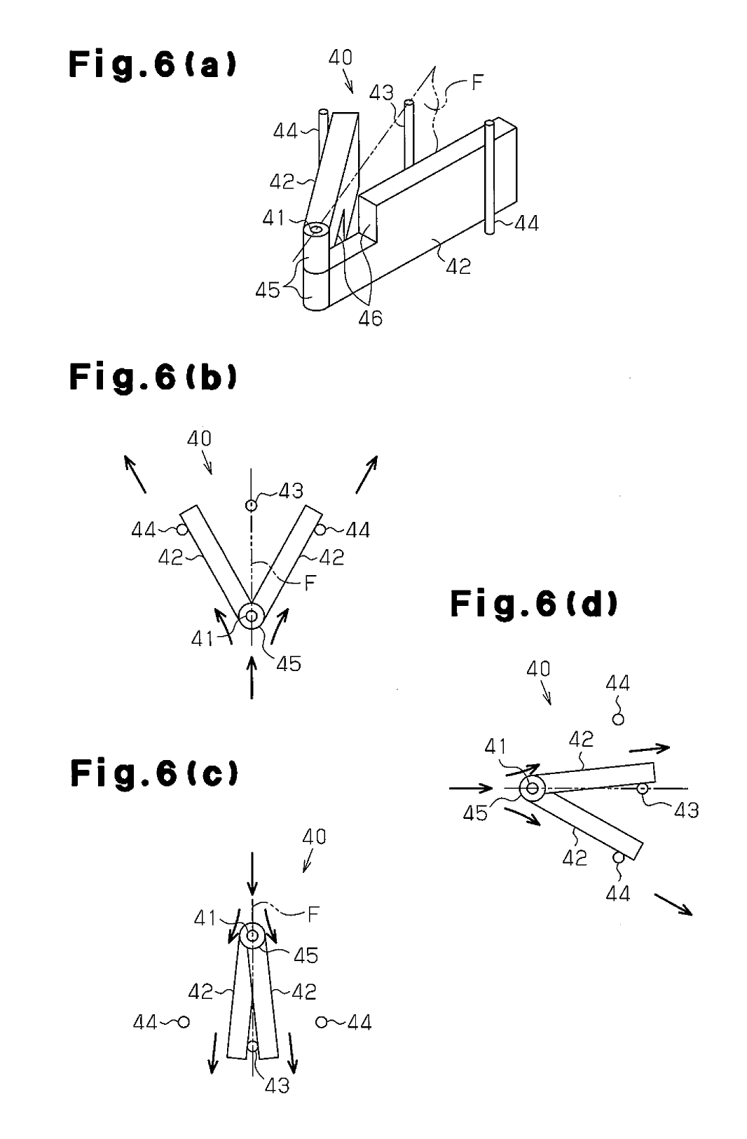

Each deflection plate 42 is elongated and flat. The deflection plate 42 includes an upper end, which is a free end, and a lower end, which forms a bearing 45 to receive the pivot shaft 41. Thus, the two deflection plates 42 are pivotally supported by a common shaft, namely, the pivot shaft 41. Each deflection plate 42 is pivotal within a pivotal range regulated by the base position regulation member 43 and the corresponding maximum pivot position regulation member 44. The pivotal ranges of the two deflection plates 42 are symmetric to each other on opposite sides of the reference plane F (refer to FIG. 6), which includes the optical axis C1 of the light source lamp 3 and the pivot shaft 41. In this specification, the position at of each deflection plate 42 when arranged closest to the reference plane F, which includes the optical axis C1 and the pivot shaft 41, is referred to as a base position or a close position (FIG. 6(c)). The position of each deflection plate 42 when arranged farthest from the reference plane F is referred to as a maximum pivot position or an open position (FIGS. 5, 6(a), and 6(b)).

The maximum pivot position is predetermined so that the cooling air from the air outlet 31 flows aside the arc tube 11 and then to above the arc tube 11. In the illustrated example, the maximum pivot position is set so that each deflection plate 42 is approximately 60 degrees from the reference plane F.

Referring to FIG. 6, the base position regulation member 43 regulates the base position of the deflection plates 42. The maximum pivot position regulation members 44 each regulate the maximum pivot position of the corresponding deflection plate 42. The base position regulation member 43 and maximum pivot position regulation members 44 may each be cylindrical rods. The base position regulation member 43 lies along the reference plane F, which includes the optical axis C1 and the pivot shaft 41. The base position regulation member 43 is arranged between and shared by the two deflection plates 42.

The two deflection plates 42 each include a cutaway portion 46 so that the deflection plates 42 do not interfere with each other when abutting each other at the base position (the position shown in FIG. 6(c)). As shown in FIGS. 5 and 6(a), the cutaway portion 46 is formed near the bearing 45 (i.e., the pivot shaft 41). The cutaway portions 46 allows for the two deflection plates 42 to be partially overlapped with each other when pivoted to the base position.

The lamp cooling system includes the air duct 32 (air outlet 31) and the airflow deflection unit 40 (deflection plates 42). The cooling fan 33 may be dedicated to the light source lamp 3 or may be shared by other parts.

The operation of the lap cooling system will now be discussed.

When the power is turned on and a projection operation is initiated, the lamp cooling system is activated as the cooling fan 33 starts to operate. The cooling fan 33 generates cooling air that flows from the air outlet 31 to the innermost part of the reflector 12 that supports the basal end of the arc tube 11.

The lamp cooling system controls the direction in which cooling air flows out of the air outlet 31 in accordance with the position of the video projector so that cooling is concentrated at the upper portion of the arc tube 11. More specifically, when the video projector is arranged in an upright projection state as shown in FIG. 7(a), the two deflection plates 42 are both arranged at the maximum pivot position and open in a V-shaped manner. In this case, the cooling air from the air outlet 31 flows aside the arc tube 11 so as to detour opposite sides of the arc tube 11 and then flows toward the innermost part, or central part, of the reflector 12 that supports the arc tube 11. Thus, the cooling air from the air outlet 31 flows along the inner wall of the reflector 12 without directly striking the lower portion of the arc tube 11 and then reaches the upper portion of the arc tube 11. In this manner, the upper portion of the arc tube 11 is strongly cooled, and the lower portion is weakly cooled. The cooling air that concentrates cooling at the upper portion of the arc tube 11 flows through the other openings 18 in the rim, or peripheral part, of the reflector 12 and is discharged out of the lamp case 20, as shown in FIG. 3(a).

When the video projector is in a suspended projection state as shown in FIG. 8(a), the video projector is upside down as compared with the upright projection state. As shown in FIG. 8(b), the airflow deflection unit 40 is located above the arc tube 11 when the video projector is arranged in the suspended projection state. The weight of the two deflection plates 42 automatically pivots and closes the deflection plates 42 as shown in FIG. 6(c). In this case, the cooling air flowing out of air outlet 31 directly strikes the upper portion of the arc tube 11 as the cooling air moves toward the innermost part of the reflector 12. As a result, cooling is concentrated at the upper portion of the arc tube 11 in the suspended projection state. In this manner, the upper portion of the arc tube 11 is strongly cooled, and the lower portion is weakly cooled. The cooling air that concentrates cooling at the upper portion of the arc tube 11 flows through the other openings 18 in the rim, or peripheral part, of the reflector 12 and is discharged out of the lamp case 20, as shown in FIG. 3(a).

When the video projector is arranged in an upwardly directed projection state as shown in FIG. 9(a), the two deflection plates 42 extend sideward as shown in FIGS. 6(d) and 9(b). When the video projector is in the upwardly directed projection state, the weight of the upper deflection plate 42 automatically pivots the deflection plate 42 until it abuts the base position regulation member 43 at the base position. This holds the upper deflection plate 42 at the base position. The weight of the lower deflection plate 42 automatically pivots the deflection plate 42 until it abuts the corresponding maximum pivot position regulation member 44 at the maximum pivot position. This holds the lower deflection plate 42 at the maximum pivot position. Thus, the cooling air from the air outlet 31 flows toward the innermost part of the reflector 12. Further, as shown in FIGS. 6(d) and 9(b), the cooling air flowing along the upper deflection plate 42 is directed toward the upper portion of the arc tube 11. In contrast, the cooling air flowing along the lower deflection plate 42 passes by and detours the lower portion of the arc tube 11 and then flows upward along the inner wall of the reflector 12. This concentrates cooling at the upper portion of the arc tube 11 in the upwardly directed projection state. In this manner, the upper portion of the arc tube 11 is strongly cooled, and the lower portion is weakly cooled. The cooling air that concentrates cooling at the upper portion of the arc tube 11 flows through the other openings 18 and out of the lamp case 20.

When the video projector is arranged in a downwardly directed projection state as shown in FIG. 10(a), the two deflection plates 42 extend sideward as shown in FIGS. 6(d) and 10(b). However, the video projector is arranged upside down as compared with the upwardly directed projection state. When the video projector is in the downwardly directed projection state, the weight of the upper deflection plate 42 automatically pivots the deflection plate 42 until it abuts the base position regulation member 43 at the base position. This holds the upper deflection plate 42 at the base position. The weight of the lower deflection plate 42 automatically pivots the deflection plate 42 until it abuts the corresponding maximum pivot position regulation member 44 at the maximum pivot position. This holds the lower deflection plate 42 at the maximum pivot position. In the same manner as the upwardly directed projection state, the cooling air flowing along the upper deflection plate 42 is directed toward the upper portion of the arc tube 11. The cooling air flowing along the lower deflection plate 42 passes by and detours the lower portion of the arc tube 11 and then flows upward along the inner wall of the reflector 12. This concentrates cooling at the upper portion of the arc tube 11 in the downwardly directed projection state. In this manner, the upper portion of the arc tube 11 is strongly cooled, and the lower portion is weakly cooled. The cooling air that concentrates cooling at the upper portion of the arc tube 11 flows through the other openings 18 and out of the lamp case 20.

The video projector of the present embodiment has the advantages described below.

With the video projector of the present embodiment, the housing 1 may be rotated about the optical axis C1 of the light source lamp 3 to change the projection direction. Thus, by rotating the housing 1 about the optical axis C1 of the light source lamp 3, the projection direction may be changed to anyone of upward, downward, leftward, and rightward directions.

The optical axis C1 of the light source lamp 3 intersects the optical axis C2 of the projection lens 2 at a right angle. Thus, by rotating the housing 1 about the optical axis C1 of the light source lamp 3, the projection direction may be changed to any angle within a range of 360 degrees.

For example, by rotating the housing 1 about the optical axis C1 of the light source lamp 3, the video projector may be arranged in an upwardly directed projection state and a downwardly directed projection state. The lamp cooling system effectively cools the light source lamp 3 when the video projector is arranged in any one of the upright projection state, suspended projection state, upwardly directed projection state, and downwardly directed projection state. This allows for the video projector to be arranged in any one of the upright projection state, suspended projection state, upwardly directed projection state, and downwardly directed projection state. Thus, the video projector may be used for almost any application.

(3) Regardless of the state, or position, in which the video projector is arranged, the airflow deflection unit 40 concentrates the flow of air to the upper portion of the arc tube 11 and concentrates cooling at the upper portion of the arc tube 11. This increases the performance of the arc tube 11 and prolongs the life of the arc tube 11. Further, there is no flow of unnecessary cooling air, and energy is not wasted.

(4) The lamp cooling system includes the air outlet 31 that delivers cooling air from below the arc tube 11 toward the innermost part of the reflector 12, which supports the basal end of the arc tube 11, when the video projector is arranged in the upright projection state. The cooling air flowing out of the air outlet 31 concentrates cooling at the upper portion of the arc tube 11.

(5) The lamp cooling system includes the two deflection plates 42 to control the flow of cooling air so that the cooling air flows directly toward the arc tube 11 or passes by and detours the arc tube 11. The two deflection plates 42 are pivotally supported by the pivot shaft 41, which lies along the reference plane F including the optical axis C1 of the light source lamp 3. Further, the two deflection plates 42 are inclined relative to the optical axis C1 of the light source lamp 3 and are orthogonal to the cooling air that flows toward the arc tube 11. Moreover, the two deflection plates 42 are pivotal in opposite directions between the base position, or minimum pivot position, at which each deflection plate 42 is arranged closest to the reference plane F and the maximum pivot position at which each deflection plate 42 is arranged farthest from the reference plane F. Accordingly, when the housing 1 is rotated about the optical axis C1 of the light source lamp 3 to change the projection direction, the two deflection plates 42 are pivoted by their own weight so that the angle between each deflection plate 42 and the reference plane F is in accordance with changes in the projection direction.

For example, when the video projector is arranged in the upright projection state, the pivot shaft 41 is located below the optical axis C1 of the light source lamp 3, and the free end is located above the basal end in each deflection plate 42. Thus, the two deflection plates 42 are pivoted about the pivot shaft 41 due to their own weight to the maximum pivot positions so as to open in a V-shaped manner. As a result, the air flowing out of the air outlet 31 does not linearly strike the arc tube 11. Rather, the air passes by the opposite sides of the arc tube 11 and detour the arc tube 11, flows along the inner wall of the reflector 12, and then reaches the upper portion of the arc tube 11. This concentrates cooling at the upper portion of the arc tube 11.

When the video projector is arranged in the suspended projection state, the pivot shaft 41 is arranged above the optical axis C1 of the light source lamp 3, and the free end is located below the basal end in each deflection plate 42. Thus, the two deflection plates 42 are each pivoted due to their own weight and hung down at the base position in a closed manner. As a result, air from the air outlet 31 directly flows toward the upper portion of the arc tube 11 and cools the upper portion of the arc tube 11 in a concentrated manner.

The pivot shaft 41 is located at the same height as the optical axis C1 of the light source lamp 3 when the video projector is arranged in the upwardly directed projection state and the downwardly directed projection state. The two deflection plates 42 are pivoted by their weight. However, the upper one of the deflection plates 42 is held in a substantially horizontal state at the base position, and the lower one of the deflection plates 42 is pivoted downward to the maximum pivot position. As a result, the upper deflection plate 42 guides the flow of air from the air outlet 31 directly to the upper portion of the arc tube 11. The lower deflection plate 42 guides the air to detour and pass by the lower side of the arc tube 11 and then flow along the inner wall of the reflector 12 toward the upper portion of the arc tube 11. This concentrates cooling at the upper portion of the arc tube 11.

The maximum pivot position is preferably set so that the cooling air from the air outlet 31 forms a current that flows aside the arc tube 11 and then reaches the upper portion of the arc tube 11. Pivoting outside this range is unnecessary. Thus, the deflection plates 42 may be pivoted within a minimum range.

(6) The maximum pivot position is set so that the cooling air from the air outlet 31 forms a current that flows aside the arc tube 11 and then reaches the upper portion of the arc tube 11. Accordingly, the airflow deflection unit 40 need only pivot the deflection plates 42 within a minimum range.

(7) The regulation members include the base position regulation member 43, which regulates the base position, and the maximum pivot position regulation members 44, which regulate the maximum pivot positions. Thus, the two deflection plates 42, which are flat plates, are pivoted to an appropriate angle in accordance with the state, or position, in which the video projector is arranged.

(8) The two deflection plates 42 are pivotally supported by the same pivot shaft 41. Further, the deflection plates 42 include the cutaway portions 46 to prevent interference between each other near the bearing 45, or the pivot shaft 41. This allows for the two deflection plates 42 to be substantially overlapped with each other in a closed state at the base position.

(9) The light source lamp 3 includes the openings 18 that are cut out from the lower, upper, left, and right parts in the rim of the reflector 12. One of the openings 18 receives the air duct 32, the distal end of which forms the air outlet 31. The other openings 18 serve as discharge ports for discharging cooling air that has been used to cool the light source lamp 3. Accordingly, the air outlet 31 and the discharge ports are formed without affecting the functions of the reflector 12, and the flow of air from the air outlet 31 is directed toward the arc tube 11.

(10) The discharge ports are formed in the rim of the reflector 12 opposing the opening 18 that receives the air duct 32 and between this opposing position and the air outlet 31. This keeps the temperature uniform around the arc tube 11 and controls the direction in which air flows.

It should be apparent to those skilled in the art that the present invention may be embodied in many other specific forms without departing from the spirit or scope of the invention. Particularly, it should be understood that the present invention may be embodied in the following forms.

In the above-discussed embodiment, the base position regulation member 43 and the maximum pivot position regulation members 44 are cylindrical rods, each having a length that traverses the deflection plates 42. Instead, as shown in FIG. 11, a base position regulation member 51, which is shorter and abuts only the edges of the deflection plates 42 may be used. In such a case, the deflection plates 42 controlling the direction in which air flows would not be by subject to interference by a regulation member.

The shape of the regulation members is not limited as long as pivoting of the deflection plates 42 is restricted. As shown in FIG. 11, a maximum pivot position regulation member 52 may be formed by bending a plate and attaching it to the wall of the air duct 32.

Further, as shown in FIG. 11, the two deflection plates 42 may each include a guide 53. The guides 53 extend outward from non-opposing surfaces, or outer surfaces, of the deflection plates 42. The guides 53 function to guide the air flowing out of the air outlet 31 toward the arc tube 11 in the innermost part of the reflector 12.

In the illustrated example, the maximum pivot position is approximately 60 degrees. However, the maximum pivot position varies in accordance with the shapes of the arc tube 11 and reflector 12. The optimal maximum pivot position may be obtained beforehand through experiments.

The air duct 32 out of which cooling air flows is received in the opening 18 that is located at the lower side when the video projector is arranged in the upright projection state. However, the air duct 32 may be received in another one of the openings 18. In such a case, the pivot positions of the two deflection plates 42 correspond to the opening 18 receiving the air duct 32. Further, the deflection plates 42 are pivotal to any of the positions shown in FIGS. 6(a) to 6(d), and cooling is concentrated at the upper portion of the arc tube 11 at any one of these positions.

The lamp cooling system is applied to the video projector that includes just one light source lamp 3. However, the lamp cooling system may be applied to a multiple light type video projector that includes a plurality of light source lamps.

The present examples and embodiments are to be considered as illustrative and not restrictive, and the invention is not to be limited to the details given herein, but may be modified within the scope and equivalence of the appended claims.

What is claimed is:

1. A video projector comprising:
a housing;
a light source lamp accommodated in the housing and including an optical axis, an arc tube, and a reflector that reflects light generated by the arc tube; and
a lamp cooling system that uses air to cool the arc tube and includes an airflow deflection unit, wherein when the housing is rotated about the optical axis of the light source lamp to change a projection direction of the video projector, the airflow deflection unit automatically changes a direction in which cooling air flows using gravitational force so that the cooling air is concentrated at an upper portion of the arc tube regardless of the changed projection direction.

2. The video projector according to claim 1, further comprising a projection lens that projects image light and includes an optical axis, wherein the light source lamp and the projection lens are arranged so that the optical axis of the light source lamp intersects the optical axis of the projection lens at a right angle.

3. The video projector according to claim 2, wherein the housing is rotated about the optical axis of the light source lamp to arrange the video projector in an upright projection state, a suspended projection state, an upwardly directed projection state, and a downwardly directed projection state.

4. The video projector according to claim 3, wherein:
the arc tube includes a basal end supported by an innermost part of the reflector;
the lamp cooling system includes an air outlet from which cooling air flows out, wherein when the video projector is arranged in the upright projection state, the air outlet guides the cooling air to flow from below the arc tube toward the innermost part of the reflector;
the airflow deflection unit includes:
a pivot shaft;
two deflection plates pivotally supported by the pivot shaft, wherein the two deflection plates pivot to change the direction in which cooling air flows out of the air outlet to a direct course in which the cooling air flows directly to the arc tube and a detour course in which the cooling air flows aside the arc tube; and
a regulation member that regulates a pivotal range of the two deflection plates, wherein:
the pivot shaft is arranged to lie along a reference plane including the optical axis of the light source lamp, is orthogonal to the flow of cooling air toward the arc tube, and is inclined relative to the optical axis of the light source lamp; and
the two deflection plates each cooperate with the regulation member to be pivotal between a base position at which the deflection plate is closest to the reference plane and a maximum pivot position at which the deflection plate is farthest from the reference plane.

5. The video projector according to claim 4, wherein the maximum pivot position is set to form an air current in which the cooling air that flows out of the air outlet flows aside the arc tube and detours the arc tube before reaching the upper portion of the arc tube.

6. The video projector according to claim 5, wherein the regulation member includes:
a base position regulation member that regulates the base position; and
a maximum pivot position regulation member that regulates the maximum pivot position.

7. The video projector according to claim 6, wherein:
the air outlet is defined by an air duct wall; and
the regulation member is formed integrally with the air duct wall to abut only an edge of each deflection plate.

8. The video projector according to claim 6, wherein:
the two deflection plates each include a basal portion, and the basal portions of the two deflection plates are commonly supported by the pivot shaft; and
the basal portions of the two deflection plates each include a cutaway portion to prevent interference between the two deflection plates when the deflection plates abut against the base position regulation member.

9. The video projector according to claim 4, wherein the two deflection plates each include a guide extending from an outer surface of the deflection plate.

10. The video projector according to claim 4, wherein:
the reflector includes a plurality of openings arranged around the optical axis of the light source lamp; and
the air outlet delivers the cooling air through one of the plurality of openings to a luminous chamber of the light source lamp, and the cooling air that has cooled the light source lamp is discharged out of the luminous chamber through the remaining ones of the plurality of openings.

11. The video projector according to claim 10, wherein the openings are arranged in a rim of the reflector at equal angular intervals around the optical axis of the light source lamp.

12. The video projector according to claim 1, wherein the airflow deflection unit includes first and second deflection plates, and wherein when the projection direction of the video projector changes, each deflection plate pivots by its own weight to change the direction in which the cooling air flows between a direct course in which the cooling air flows directly to the arc tube and a detour course in which the cooling air flows aside the arc tube.

13. The video projector according to claim 12, wherein the first and second deflection plates automatically pivot when the projection direction of the video projector changes to divide the flow of cooling air into a direct current in which the cooling air flows directly toward the arc tube and a detour current in which the cooling air flows aside the arc tube.

14. The video projector according to claim 12, wherein:
the airflow deflection unit includes first, second, and third regulation members that regulate a pivotal angle of the first and second deflection plates;
when the first and second deflection plates both abut the first regulation member, the first and second deflection plates guide the cooling air toward the arc tube;
when the first and second deflection plates respectively abut the second and third regulation members, the first and second deflection plates divide the flow of cooling air into detour currents flowing aside the arc tube at opposite sides of the arc tube; and
when one of the first and second deflection plates abut the first regulation member and the other one of the first and second deflection members abut one of the second and third regulation plates, the first and second deflection plates divide the flow of cooling air into a direct current flowing toward the arc tube and a detour current flowing aside the arc tube.
